(19) United States
(12) Patent Application Publication
(10) Pub. No.: US 2025/0345978 A1
(43) Pub. Date: Nov. 13, 2025

(54) PRODUCTION OF PARTS BY MOLDING OR EXTRUSION AND SYSTEM

(71) Applicant: Momentive Performance Materials GmbH, Leverkusen (DE)

(72) Inventors: Thorsten Haeuser, Bergisch Gladbach (DE); Jan Geboers, Düsseldorf (DE); Clemens Trumm, Sankt Augustin (DE); Emily Sarah Judge, Chorley (GB)

(21) Appl. No.: 18/871,192

(22) PCT Filed: Jun. 5, 2023
(86) PCT No.: PCT/EP2023/064931

§ 371 Date: Dec. 3, 2024

(30) Foreign Application Priority Data
Jun. 3, 2022 (EP) 22177130.6

(51) Int. Cl. B29C 45/78; B29C 37/00; B29C 45/73

(52) U.S. Cl. CPC B29C 45/78; B29C 45/7306; B29C 2037/80; B29C 2037/903; B29C 2945/76464; B29C 2945/76732; B29C 2945/76892; B29C 2945/76939

(57) ABSTRACT

The present invention refers to a method to produce parts by shaping and curing a raw material comprising the steps:
a batch of raw material is produced;
at least one cure property of the raw material of the sample is determined;
shaping the raw material;
the time required for the shaped raw material to cure is determined taking into account the at least one cure property;
curing of the shaped raw material until the determined time has elapsed.

The present invention also refers to a database and a system for producing such parts.

The present invention refers to the production of parts by shaping and curing a raw material. The shaping can take place by injection molding, compression molding, pultrusion or extrusion e.g.. The raw material is brought into a mold for the production of a part or shaped in another way. The shaped raw material cures. The finished part can be removed from the mold after curing or directly obtained in the case of extrusion. The present invention also refers to a database and a system for producing such parts.

Raw material must remain in a mold until it is sufficiently cured. In order to reliably achieve the required curing, the raw material usually remains in the mold longer than is necessary for curing. This reduces the productivity of the manufacturing process.

Document “Hwaseop Lee, Kwangyeol Ryu, Youngju Cho, A framework of a smart injection molding system based on real-time data, Elsevier, Procedia Manufacturing 11 (2017) 1004-1011, doi: 10.1016/j.promfg.2017.07.206” refers to improved productivity in the field of injection molding. Document “Albrecht Becker, Roy Ovink, prediction and validation of rubber compound optimal curing conditions, Rubber & Plastic News, Mar. 23, 2020, pages 16-19” deals with the improvement of curing conditions.

It is the object of the invention to improve the production of parts made from raw materials which cure for example in a mold.

The object of the invention is solved by a method comprising the features of claim 1 and a database, and a system comprising the features of the further independent claims. Dependent claims refer to preferred embodiments of the invention.

A process which solves the object of the invention comprises the following steps. A batch of raw material is produced. The raw material is such that it can be cured. At least one cure property of the raw material of the sample is determined. Raw material from the batch is put into a mold or shaped in some other way. The time required for the shaped raw material to cure is determined taking into account the one or more cure properties. The shaped raw material is cured until the determined time has elapsed.

Parts are pieces made from the raw material by curing. Examples of parts are: Springs for keyboards, catheters, masks for ventilators, hoses, cable insulation, seals, baby pacifier, insulators for high voltage lines, tires, light switches, domestic power outlets, conveyor belts, bellows, adjusting rings, pushers, pot and pan handles, connector and sensor housing, printed circuit boards, headlight reflectors, relais. These examples can be made from silicone rubber. Further examples of parts are: adjusting rings, pushers, pot and pan handles. These examples can be made from phenolic. Further examples of parts are: connector and sensor housing or printed circuit boards. These examples can be made from epoxy, melamine, or polyester. A further example is a car headlight reflector which can be made from BMC (bulk molded compound).

The raw material cures due to a chemical reaction. The raw material is a material that can be cured by crosslinking. The raw material can consist of two or more components that are mixed together for curing. The components are then manufactured separately from each other. The components are mixed in time just before the production of a part.

A batch of raw material is a defined quantity of raw material processed in one process or series of processes so that it could be expected to be homogeneous. There are then no different or at least nearly no different curing speeds. For example, one or more raw material properties of a batch can be measured regularly. It can thus be determined whether one or more raw material properties have changed. If it is determined that one or more raw material properties have changed sufficiently clearly, a new batch is present. For example, one or more threshold values can be specified for changes in one or more material properties. If one or more material properties change in such a way that at least one predefined threshold value is exceeded, a new batch is present.

A batch within the meaning of the invention does not exist if raw material is always produced in the same way by the same processing unit without observing a defined quantity limit above which the one or more cure properties of the raw material are re-determined. For example, if raw material or a component of the raw material was not continuously produced in a mixer and thus batchwise, then that quantity of raw material produced in the mixer is regularly a batch of the raw material respectively a batch of a component of the raw material within the meaning of the invention. The weight of a batch produced in this way is typically up to 3 or up to 10 tons especially in the case LSR or up to 20 tons especially in the case of EPDM. The weight of a batch produced in this way is typically at least one or two tons. Thus, if the raw material includes several components, then there can be one batch of each component, typically weighing up to 3 tons and or at least one or two tons.

The weight of a batch can be between 40 and 100 kg. This is for example true for LSR (liquid silicone rubber). A batch can weigh up to 250 kg. This is typical for car tyres, for example.

So if, for example, 3 tons were produced non continuously in a mixer, one or more cure properties are subsequently measured with which curing times can be determined. If 3 tons of the identical raw material or a component of the raw material are subsequently produced again in the mixer in a non-continuous manner, the one or more cure properties with which curing times can be determined are measured again. In this case, 3 tons are a defined quantity within the meaning of the present invention. The material is homogeneous because it has been produced in the same mixer in the same manner and there can be no change in cure properties due to different material properties of starting materials. There is therefore a batch within the meaning of the invention. If, instead, the raw material or a component of the raw material continues to be produced without the one or more cure properties being re-measured at regular intervals, it is not a batch within the meaning of the invention.

A batch of raw material may have been produced from two or more starting materials. In practice, a batch can be obtained as follows. As soon as a new batch of starting material is processed, this is treated as a new batch of raw material. Thus, curing properties are then determined anew.

In practice, production periods may be specified. Once a production period has been terminated, the raw material that is subsequently produced is treated as a new batch of raw material. The production periods are then chosen to be short enough to ensure that the properties of a batch of raw material cannot have changed, or at least not significantly. In practice, quantities may have been fixed. Once a certain quantity of raw material has been produced, the subsequently produced raw material is treated as a new raw material batch. A quantity is then chosen so small that the properties of a raw material batch cannot have changed, or at least not significantly. Thus, a maximum weight or a maximum volume may have been defined as the quantity. If the production volume of raw material reaches the maximum weight or the maximum volume, the raw material produced subsequently is treated as a new batch of raw material.

The one or more cure properties are properties of the raw material, on which the curing time of the raw material of the sample depends. Cure properties are material properties of the raw material of a batch that are used to determine optimized curing times. If the raw material consists of more than one component, cure properties of each component can be determined alternatively or additionally. According to the invention, the cure properties are determined anew for each batch.

It is not necessary for the shaped raw material to fully cure in order to be removed from a mold or to be processed further. As a rule, it is sufficient that the raw material in the mold respectively the shaped raw material reaches a desired curing degree.

The determined time is such that the desired degree of curing is achieved. The cured part can then be removed from the mold. This is especially true for raw material that cures even at room temperature. However, it is also possible to wait for a predefined period of time to be sure that the desired degree of curing has been achieved.

A mold is a shaped piece which comprises a cavity for shaping liquid or pliable raw material. The mold may consist of two shells. One or more openings may lead into the cavity. The opening can be closable. The cavity can be cylindrical, for example, to make a hose. The cavity can be in the shape of a baby pacifier to make a baby pacifier. The cavity can be in the shape of a spring to make a spring. The cavity may be in the form of a ring to make an annular seal.

Shaped raw material may also have been created for example by screen printing, dip coating or ink-jet printing processes. A mold with a cavity is not absolutely necessary to shape the raw material. For example, the raw material can be applied to a substrate as a layer in order to shape the raw material. The raw material then has the shape of a layer and is a shaped material within the meaning of the present invention.

The solution according to the invention can significantly reduce the time required for curing. This is especially true when relatively large parts are produced, weighing at least 1 kg, for example. Overall, a significant productivity gain can be achieved even though the measurement effort and/or computational effort required to determine the cure properties is very large and the measurement effort and/or computational effort must be repeated for each batch. Further, it is necessary to determine anew time required for the shaped raw material to cure as soon as a new batch has new cure properties. It has been found that the testing and calculation amount may increase by much more than 50% for each batch of the raw material respectively for each batch of the components compared to what is usually done. However, it has been found that this can save up to 30% in curing time compared to the case where a curing time is not determined for each batch of raw material respectively for each batch of the components. Overall, productivity can be significantly improved despite the initial additional effort. Surprisingly, the productivity benefit is so great that it more than compensates for the initial additional effort. Overall, the technical effort required to manufacture parts can be significantly reduced.

If the shaped raw material is heated for curing, the supply of heat is stopped when the determined time has elapsed. When the shaped raw material is irradiated to cure, the irradiation is stopped when the specified time has elapsed.

The raw material curing in a mold is removed from the mold when the required time previously determined has elapsed. If the mold is heated to cure the raw material within the mold, it is possible to stop the supply of heat by removing the finished part from the mold as soon as the determined time has elapsed. The raw material therefore remains in the mold only until the required time previously determined with the aid of the sample of the batch has elapsed. If the raw material has been formed in any other way, then the part can be removed when the required time previously determined with the aid of the sample of the batch has elapsed. After that, a next part can be produced in the same place.

The raw material can be such that curing produces parts made from elastomers, thermosets or other plastics. Curing can result in parts made of silicone, rubber or a thermosetting plastic, for example. The step of curing can include heating the raw material in the mold respectively the shaped raw material. The step of curing can include irradiating the raw material with UV light.

LSR (Liquid Silicone Rubber), HCR (High Consistency Rubber Silicone solid rubber), EPDM (ethylene-propylene-diene rubber), SBR (styrene butadiene rubber), EPDM (ethylene-propylene-diene rubber), FKM (fluoro rubber) are examples of raw materials.

EPDM (ethylene-propylene-diene rubber) is used to make window seals, cable sleeves and insulators. SBR (styrene butadiene rubber) is a component of tyre mixtures in addition to NR (natural rubber). HNBR (High Density Nitrile Butadiene Rubber) is a typical material for dampers and bellows. FKM (fluoro rubber) is a typical material for fuel lines.

Epoxy resins for electronic elements (Baekelite), ignition coils in ICEs (German train) are examples of raw materials.

The volume of the cavity of a mold can be a few milliliters, for example at least one milliliter. The volume of the cavity can be many liters. As a rule, the volume is less than 10 liters. Nevertheless, a volume of, for example, up to 60, 100 or 500 liters is possible. For example, the weight of a baby pacifier can be 15 g. The volume of a corresponding cavity is then only a few cubic centimeter. The weight of a high-voltage insulator can be 5 to 8 kg. The volume of a corresponding cavity is then several liters. For example, the weight of a single contact connector can be 0.1 to 0.2 g. The volume of a corresponding cavity is then less than 1 milliliter.

A processing unit through which the raw material is cured can include a plurality of cavities so that a plurality of parts can be produced simultaneously.

In an embodiment of the invention a sample is taken from the batch. One or more cure properties of the raw material of the sample are then determined.

A sample is a very small portion from the batch. The volume, respectively the weight, of the sample is chosen at least so large that this is sufficient to be able to determine one or more desired cure properties.

Advantageously, however, the volume, respectively the weight, of the sample is larger than the volume needed respectively the weight needed to determine the cure properties sought. Raw material from the sample can then be stored so that the cure properties of the raw material can be re-examined at a later date. It is then possible, for example, to correct one or more stored cure properties at a later date if errors have been detected. The weight of such a sample is therefore typically 0.5 kg to 5 kg. The weight of such a sample can be 1 kg.

If the raw material includes several components, then a sample of each component is taken from the respective batch. The weight of each sample of each component is then typically 0.5 kg to 5 kg.

As a rule, the time required for curing a shaped raw material is calculated by a computer. There may be at least one mathematical equation by which the time required for a curing a shaped raw material can be calculated. Alternatively, the required time for curing a shaped raw material can be determined by computer simulation. Calculations can be performed by a computer of a processing unit. Computer simulations can require a very powerful computer. Therefore, computer simulations are preferably performed by a computer which is not a computer of the processing unit.

Calculations can be performed by using the Deng-Isayev model, the Sestak-Berggren model, or the Kamal model. All of them describes vulcanization reaction kinetics in terms of a mathematical model so that curing behavior may be predicted for different heat histories. Other mathematical models can also be used.

The time required for curing is preferably determined as a function of the processing unit used. If a different processing unit is used, the one or more equations may change, or the computer simulation is adjusted. Two processing units are different if they are not built in the same way and therefore there are design differences. To adapt one or more equations respectively a computer simulation to a processing unit can further improve productivity. If a mold is replaced in a processing unit, this may already result in the time required for curing having to be redetermined. This is especially true if the cavities of the molds differ or the material from which the molds are made. However, once a time required for curing a shaped raw material has been determined, this time does not need to be determined again to produce identical parts. Identical parts mean parts which has the same shape and are made of the same raw material of the same batch by the same mold. However, the time for curing to produce a part is determined again if other parts are to be produced or raw material from another batch is used. Thus, if a cavity of a processing unit is replaced by a new cavity and the volume and/or shape of the cavities are different, then there are two processing units which are different within the meaning of the present invention.

Preferably, the processing unit includes the computer, which determines the time required for curing by calculation. A computer of a processing unit controls only this processing unit and/or performs calculations only for this processing unit. Thus, it is not a computer that can be accessed by a plurality of processing units via the Internet so that the computer controls a plurality of processing units and/or performs calculations for a plurality of processing units. It has been found that the computational effort to determine the time required for curing is sufficiently small so that a processing unit's computer is not overloaded. There is no need to provide a separate computer in this embodiment because a processing unit always has its own computer. This embodiment can also ensure that the software used to determine the time required is the suitable software which is adapted to the processing unit.

In an embodiment of the invention, there is a database that stores the determined one or more cure properties for each batch. One or more cure properties are also stored for further batches. The database therefore contains data that can be used to identify each batch. Thus, data identifying each batch is stored to find a batch being searched for and the associated one or more cure properties. Computers that determine the time required for a cure are connected to the database or are configured to do so. In particular, the computers can be connected to the database via the Internet. Each computer is set up to search for a desired batch and obtain the associated cure properties. Each computer belongs to a processing unit which comprises at least one mold or other means to shape raw material. This means that many different processing units can produce parts without requiring a separate database with cure properties stored in it for each processing unit. This further improves productivity.

By the invention, i.e. by a system of the present invention, curing times can be calculated in an automated manner. Thus, in an embodiment of the invention, no time is specified for curing, but only a desired degree of curing. Subsequently, the system according to the invention automatically calculates the time required to achieve the desired degree of curing. Curing is then carried out by a processing unit according to the calculated time. The quality of the manufactured parts can thus be improved and or equalized.

In an embodiment, each batch comprises a code that can be used to identify the batch. This code or an information based on the code can be transmitted to the database by a computer. Subsequently, a computer can obtain the cure properties belonging to this batch in this way. In particular, any of the aforementioned computers is capable of doing this.

In one embodiment, the code includes the address to the database. By reading the code, the database can be contacted automatically, for example.

In an embodiment, each batch comprises information about the determined cure properties. Thus, by reading out the determined cure properties or a corresponding code, the cure properties are obtained which are needed for the production of parts. A database is then not necessary.

The determined cure properties or a corresponding code may be printed on a package of the batch. The determined cure properties or a corresponding code may be printed on a package insert of the batch. However, the determined cure properties or a corresponding code can also be stored electronically on a storage medium that can be read by the computer. The storage medium may be an RFID chip.

The code can be a number or a combination of numbers and letters. The computer may include an input device into which the number or combination of numbers and letters may be entered. The code can be a bar code or a QR code. The computer can be connected to a code reader and thus to bar code reader respectively a QR code reader for example. The connection can be a wireless connection. The connection can be a cable connection. The computer can read the code with the help of the bar code reader respectively the QR code reader. Once the computer has received the code, the computer can obtain the one or more cure properties via the database. Once the computer has received the one or more cure properties, the computer can determine the time required to cure a shaped raw material. Data exchange can be made using known interfaces such as the EUROMAP interface.

Alternatively, a code reader may be configured to connect to the database after reading the code. The code reader can be configured to receive the cure properties of the batch from the database after the connection is established. The code reader may be configured to send the obtained cure properties to a computer, which determines the time required for curing.

In an embodiment, the code includes an electronic address through which the database can be accessed. This may be an internet address. It is thus ensured that the computer contacts the correct database to retrieve cure properties.

In an embodiment, the code includes access data for the database. The access data may include, for example, a username and/or a user password. The database can thus be protected from unauthorized access.

The code reader can be scanner or a cell phone on which there is a software that can be used to read a code. Preferably, a cell phone is the code reader to minimize the number of devices needed. The number of devices required is minimized because practically every person has a cell phone with a camera function and therefore existing cell phones can be used. With this embodiment, only software that can be installed on common cell phones needs to be provided.

For the production of parts, a feeding device can be provided, with which the raw material is brought from a container into a mold. On the container may be placed the code. The feeding device may include a camera with which the code can be read. Thus, the feeding device may comprise the code reader. A pump can be such a feeding device when the material is liquid.

Material cure properties that can be used to optimize the production of parts from a shaped raw material by curing are heat capacity, thermal conductivity, heat transfer coefficient. This applies to such a raw material heated to cure shaped raw material quickly.

Other material properties that can be helpful for determination of curing times for shaped raw material are density and viscosity. Indeed, by injecting the raw material into a mold, the raw material can be heated. In order to be able to take this into account, material properties with which this influence can be determined may be of interest. Density or viscosity are cure properties within the meaning of the invention if they are used to determine curing times.

In an embodiment of the invention, one or more cure properties of a batch respectively of a sample of the batch are determined at several different temperatures and stored in the database, if the raw material is heated in a mold to cure it quickly. Preferably, the one or more cure properties are determined at least at three different temperatures. Measuring at three different temperatures is sufficient to predict the curing behavior at a different temperature. For this reason, it is advantageous to measure at three different temperatures.

Cure properties can be measured at more than three temperatures to further increase prediction accuracy. However, the prediction accuracy is then not improved significantly. It therefore makes technical sense to measure the cure properties only for three different temperatures.

If cure properties are measured for only three different temperatures, the difference between two different adjacent temperatures is advantageously at least 10° C. The difference between two adjacent temperatures is advantageously no more than 20° C.

The temperature range is preferably selected in such a manner that the temperature that is anticipated to be applied to the curing of the shaped raw material is within the selected temperature range.

For example, the temperature expected to be applied for curing of the shaped raw material is 130° C. 120° C. to 150° C. can then be selected as the temperature range. 150° C. can then be selected as the first temperature of the temperature range. 135° C. can then be selected as the second temperature of the temperature range. 120° C. can then be selected as the third temperature of the temperature range. The temperature difference between two adjacent temperatures is then 15° C. and thus at least 10° C. and no more than 20° C. At least one cure property is then measured at three different temperatures: 150° C., 135° C. and 120° C. But the temperatures expected to be applied for curing can also be lower. For example, in the case of silicone, the maximum temperature should not exceed 130° C., preferably 120° C. At least one cure property may be then measured at the following three different temperatures: 120° C., 110° C. and 100° C. or 120° C., 100° C. and 80° C.

For example, cure property may be measured at the following three different temperatures Room temperature, 35° C. and 50° C.

Thus, one or more cure properties of a sample are determined at several different temperatures and stored in the database to further improve productivity in an embodiment of the invention. A first predetermined temperature can therefore be between 110° C. and 170° C., for example. A second predetermined temperature can therefore be between 110° C. and 160° C., for example. A third predetermined temperature can therefore be between 90° C. and 150° C., for example. Thus, a first temperature can be 110° C., a second temperature can be 100° C., and a third temperature can be 90° C. Thus, a first temperature can be 170° C., a second temperature can be 160° C., and a third temperature can be 150° C. Thus, a first temperature can be 150° C., a second temperature can be 130° C., and a third temperature can be 110° C.

A first predetermined temperature can be between 100° C. and 130° C. A second predetermined temperature can be between 110° C. and 80° C. A third predetermined temperature can be between 100° C. and 70° C. This is especially true for silicone.

Preferably, the determination of one or more cure properties involves the determination of the curing state at a given temperature as a function of time. It can be a curve, which is determined and stored in a database. Such a curve may show the degree of curing as a function of time at a given temperature. The degree of curing may be represented by a torque or a state of cure. The state of cure (also called “SoC”) as a function of time t may have been calculated by the equation:

$$S o C ( t ) = ( M ( t ) - ML ) / ( MH - ML ) ,$$

wherein ML is the measured minimum torque, MH is the measured maximum torque and M (t) is the torque measured as a function of time.

However, the determination of cure properties may also include that only some typical cure properties have been determined. As cure properties, the time tX may have been determined at a given temperature. TX is the time required to reach MX at a given temperature, wherein MX=(MH-ML)·0,X+ML. For example, X may be 90. Thus, t90 is the time required to reach M90, wherein M90=(MH−ML)·0.9+ML. T90 is considered as an optimum cure time for high-quality production in many processes.

Another typical time that is of particular interest is the time t50. T50 is the time required to reach M50 at a given temperature, wherein M50=(MH−ML)·0.5+ML.

Another typical time that is of particular interest is the time t60. T60 is the time required to reach M60 at a given temperature, wherein M60=(MH−ML)·0.6+ML.

Thus, the times t90, t60 and/or t50 may have been determined as cure properties for a sample at one or more predetermined temperatures.

In an embodiment of the invention, the times t0.2 and/or t10 may have been determined as cure properties for a sample at one or more predetermined temperatures. t0.2 can be the time for the end of the incubation phase. Then the torque slowly increases and the curing starts. T10 often describes the first phase of curing. Thus, to determine the times t0.2 and t10 can be helpful.

The torque can be measured by a rheometer experiment on a moving die rheometer at a fixed temperature. A moving die rheometer is also known as MDR. Another measurement device that can be used to determine suitable cure properties is the rubber process analyzer which is also known as RPA. RPA can be used to perform a rheological test procedure to analyze raw elastomers. RPA operates in a range of up to 230° C., for example.

In an embodiment of the invention, not only cure properties of the raw material of the sample are determined and stored in a database, but also other material properties that are not used to determine curing times for shaped raw material. When raw material is heated in a mold, the material expands in the mold. It may be necessary to take the expansion into account to produce defect-free parts. Therefore, one or more material properties may have been determined and stored in the database that relate to the coefficient of expansion of the raw material or a component of the raw material. Further material properties can thus be stored in the database in a retrievable manner to improve the manufacture of parts.

From the stored cure properties, it is now necessary to calculate how the shaped raw material cures. This is because the curing speed for the shaped raw material also depends on the mold characteristics or type. This is, for example, due to the fact that volumes within the shaped raw material are heated at different rates.

For example, a computer can use simulation software for instance Sigma 3D. The computer may first determine how quickly the shaped raw material would fully or 90% cure at a temperature which may be between two of the three temperatures stored in the database.

In a mold, the heat applied from the outside is distributed at different rates. Accordingly, areas respectively volumes within the mold cure at different rates. Computer simulation may be used to determine the volume within the shaped raw material that cures the slowest. The simulation software determines how much time is needed for the raw material in this volume to cure in the desired manner, i.e. to reach a desired degree of cure. When this determined time has elapsed, the then finished part can be removed from the mold.

It is true that a shaped raw material could be cured particularly quickly at a temperature of 220° C., for example. However, this does not mean that it is favorable to cure at this temperature of 220° C. The reason is that very high temperatures lead to large material expansion, which can cause problems. In addition, high temperatures can have a negative impact on the filling process, as material may cure in thin cross-sections during the injection phase. The temperature for curing must therefore be selected so that no excessive problems occur. During heating, the shaped raw material cures. Therefore, a heating process should not take too long. Also, for this reason, it is unfavorable to cure the shaped raw material at the temperature that accelerates curing to the maximum.

To cure such a material at a desired temperature in a mold, the mold is preferably brought to the desired temperature. The heat is then transferred from the mold to the shaped raw material. Therefore, the mold is preferably made of metal to transfer heat well.

The temperature of the mold is preferably kept constant and is not changed even if cure properties change because the batch of raw material has been changed. In this embodiment, a new time for full/complete curing the shaped raw material in the mold is then determined when a cure property has changed. Alternatively or complementarily, the raw material can be brought to a different initial temperature when the raw material is brought into the mold.

For example, the temperature of a mold is a constant 140° C. It has been determined on the basis of cure properties that raw material in the mold must then be cured for 5 seconds to achieve the desired degree of cure. For example, the desired degree of cure maybe fully cured. The initial temperature of the raw material is then 20° C., for example. The initial temperature is the temperature of the raw material when the raw material is still outside the mold but is to be brought into the mold in a timely manner. A cure property now changes because raw material comes from a different batch. A new curing time is then determined by a computer and/or a new initial temperature of the raw material. It may then have been determined, for example, that the curing time is now 6 seconds due to the change of the batch at 140° C.

In an embodiment of the invention, the one or more cure properties are also used to predict the technical effort required to manufacture the parts. Due to the invention, it is possible to predict how long curing times will be for defined raw material batch and shape of mold. Since curing times can be predicted very accurately, it is possible, for example, to predict very precisely how many parts can be produced per unit of time, for example per hour. Delivery times can thus be predicted very accurately. This allows subsequent manufacturing processes to be optimized, for example. This is especially the case if the manufactured parts are needed for the production of other items. Other stored material properties can also be used advantageously in this way.

In an embodiment of the invention, there is a control unit that controls the curing process fully automatically. Changed curing times then do not have to be entered manually in a processing unit. Instead, the control unit registers fully automatically when a cure property of a raw material has changed and automatically adjusts a curing time, for example. After the curing time has elapsed, the processing unit may then eject the manufactured part from the mold fully automatically. A computer of a processing unit which is configured to shape raw material and which is configured to cure the shaped raw material may be the control unit.

In an embodiment of the invention, a processing unit code is provided on the processing unit used for shaping the raw material and curing the shaped raw material. Through the processing unit code, the processing unit can be identified. The processing unit code applied to the processing unit is then read by the code reader.

In an embodiment, the code reader is configured to transmit the read processing unit code of the processing unit to the control unit, if control unit is not a computer of the processing unit. In this way, the control unit knows which processing unit is being used. This makes it particularly easy to implement fully automatic production.

In an embodiment, the code reader is configured to establish a data connection to a computer of the processing unit after reading the code of the processing unit. The data connection can be a wireless data connection, for example a Bluetooth connection or a Wi-Fi connection. Following this, the code reader can send information to the computer that it needs so that parts can be produced automatically. For example, cure properties can then be sent to the computer that the code reader has obtained from said database.

The processing unit code can be a code like the one described before. For example, it can be a barcode or a QR code.

In an embodiment of the invention, the manufactured article is marked so that it can be uniquely identified. Thus, the batch (raw material) can be clearly assigned. This means that the production time, processing unit, cavity can be clearly assigned to the manufactured article. The marking may be, for example, a number or a combination of numbers and letters. The marking may, for example, have been produced by a laser. Fully automated production now enables traceability. For this purpose, the control unit at least stores when the part was produced by which processing unit in which cavity of the processing unit. Preferably, manufacturing conditions such as the curing time and/or cure properties of the raw material are also stored. For example, if a manufactured part is found to be defective at a later date, it can be determined how, and by which processing unit the part was manufactured. It can then be analyzed why the defect occurred. Defects found in this way can then be avoided in the future.

The invention enables an automated method to reduce curing times caused by batch to batch variations in molding and extrusion processes for crosslinking materials like rubber- or duroplastic materials by use of simulation software to forecast the slowest curing speed in a rubber or duroplastic part or profile.

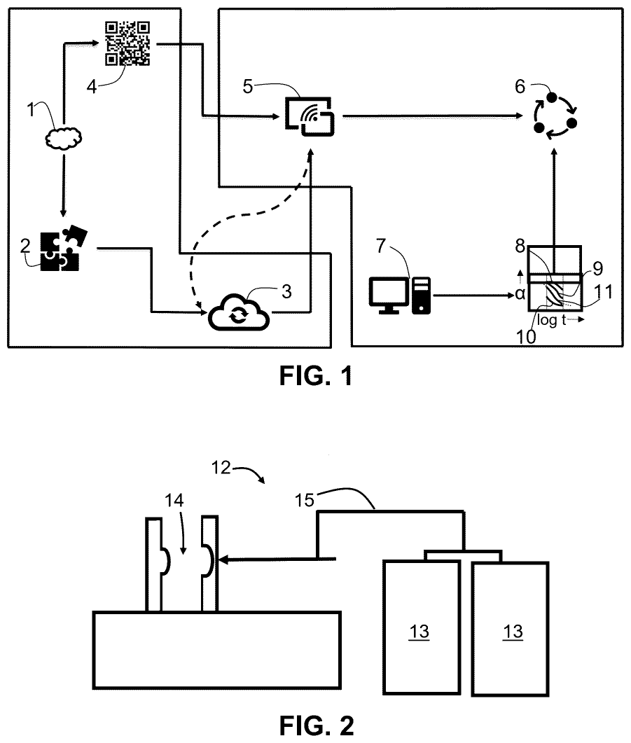

A schematic drawing which explains the principles of this invention is shown in FIG. 1.

A batch of raw material that can be cured has been produced. A sample 1 is taken from the batch by a supplier of the batch of raw material. The supplier determines cure properties 2 of the raw material of the sample 1 for three different temperatures. The supplier stores the cure properties 2 as data in a database 3. The supplier creates a QR code 4 and attaches the QR code 4 at a package of the batch of raw material.

A producer of parts receives the batch of raw material which does not comprise the sample anymore. A producer's code reader 5 reads the QR code which is on the package of the raw material. The code reader 5 sends the code to the database 3. As a response, the database 3 sends the stored cure properties 2 belonging to the batch of raw material to the code reader 5. The code reader 5 sends the received cure properties 2 to the processing unit 6 which produces parts from the raw material of the batch by shaping and curing. The processing unit 6 comprises a computer 7. The computer 7 calculates from the received material properties three different cure curves 8, 9, 10 for the three different temperatures T1, T2, T3. The temperature of the cavities of the processing unit is TO. TO is a temperature between the temperatures T2 and T3. Based on the three different cure curves 8, 9, 10, the computer 7 calculates cure curve 11 for the temperature TO. The computer 7 knows due to the calculated cure curve 11 which time is needed in order to sufficiently cure the raw material within a mold. The computer now controls the curing process in such a manner that the curing times are as short as possible to optimize the productivity.

In this example, the computer 7 could be the computer that generates a “master equation” using Sigma 3D or other simulation programs, i.e. the equation that is used to calculate a slowest volume element. The slowest volume element of a cavity is a volume element where the curing time is the longest.

This equation, which can also take into account the reaction kinetic properties of the materials, can then be transferred to the processing unit 6 (via USB or WLAN, for example). This equation then describes the shape or the geometric boundary conditions of the part to be produced and is assigned to the processing unit 6 after transfer of the equation to the processing unit 6. The relation of the batch material (which has different curing kinetic properties from batch to batch) with the master equation then can take place on processing unit 6.

A schematic drawing of a processing unit 12 (as an example of processing unit 6 on FIG. 1) is shown in FIG. 2. The processing unit 12 may comprise a mixing unit. The mixing unit may comprise two containers 13 for storing batch materials and a mixing equipment for mixing the batch materials. The processing unit comprises a cavity 14 and a feeding system 15. The feeding system 15 can feed the mixed batch materials to the cavity 14.

A processing unit may comprise a plurality of cavities 14.

To investigate the impact of batch to batch variations on materials one economically relevant liquid silicone rubber grade has been chosen and investigated. During these investigation the variance in curing behavior especially the t10, t60 and t90-times where tracked for 93 batches to identify the slowest and fastest batch. The difference of t90 time for the slowest and fastest LSR was 100% (1.5 min to 3.0 min) measured on the Rubber Process Analyser. The difference of t60 time for the slowest and fastest LSR was 1.1 min to 1.6 min measured on the Rubber Process Analyser. The difference of t10 time for the slowest and fastest LSR was 1.0 min to 1, 1 min measured on the Rubber Process Analyser.

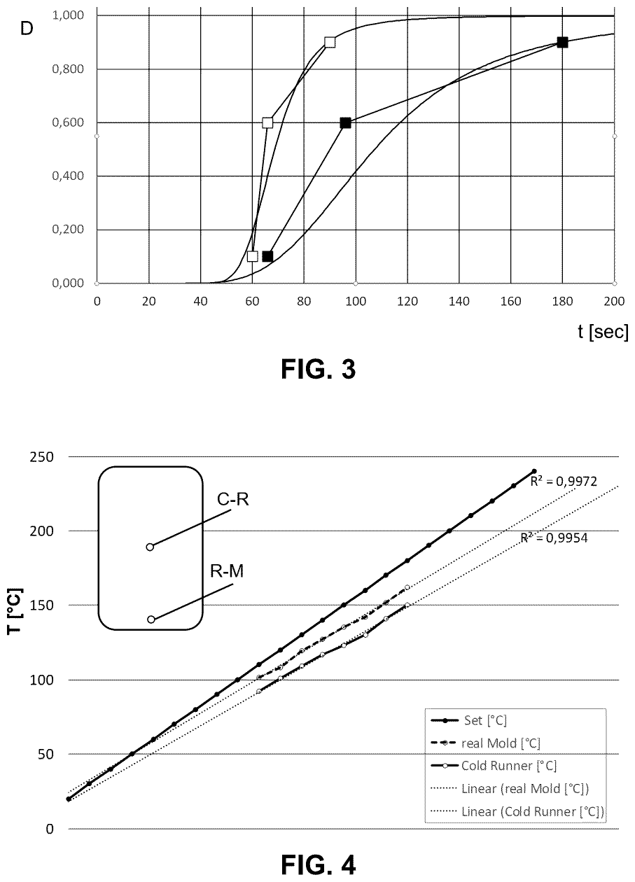

With these data the mathematical model of Isayev-Deng was used to fit the curves manually and thus to create a data package for the Sigma 3D material library and thus for a known 3D simulation software. FIG. 3 shows the fitting of the slowest (closed squares) and fastest (open squares) batch material based on t10, t60 and t90 values. In FIG. 3, the degree of crosslinking D is plotted against time t in seconds. The following values were determined for the model of Isayev-Deng: T0=32500, t=4.80E-36, n=3.2, k0=3.12E+24, E0=1.522, R=8.31448 for the slowest batch material and T0=30000, t=3.84E-33, n=4.05, k0=3.21E+24, E0=1.520, R=8.31448 for the fastest batch material. With these data it was possible to simulate the heating time of a representative mold (2 mm test sheet mold which is also available for molding trials) and to identify the curing time for the slowest and the fastest material batch and thus to identify the productivity difference between these two batches. The simulation showed a heating time reduction between the fastest and the slowest batch, which was between 10 and 60% depending on the mold temperature. FIG. 4 shows temperature curves comparing theoretical temperatures on the vertical axis and the measured temperatures on the horizontal axis, wherein T is the mold temperature and C_R means cold runner and R-M means Real Mold. In FIG. 4, the top curve shows temperatures set on the machine (Set [° C.]). The other two curves show temperatures measured at two different locations in the mold. The middle curve “real mold [° C.]” refers to a location within the cavity. The lowest curve “Cold Runner [C]” refers to a location at the cold runner. Cold runner means an access to the cavity that is actively cooled. R² means a correlation factor determined by curve fitting.

To validate the simulation results, the trials were repeated on a comparable mold in real molding trials. The 2 mm test-sheet mold as above was used for these trials. Based on the calculation, the coldest and thus also slowest curing spot is the area of the gate. This area is also the interface between the cold-runner and the hot mold surface. As a consequence, the interface is significantly colder compared to the rest of the mold and thus leads to the slowest curing of the material (confirmed by measurements of the real mold).

This effect provides a perfect opportunity to investigate the real curing process. For that the gate area was used as indicator of curing time as the surface of the shaped respectively molded parts shows easy warping in the case of under-curing.

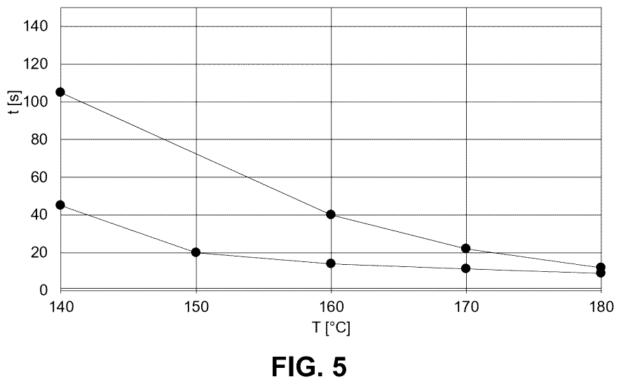

The molding trials confirm the simulation results and the large variance between the fastest and the slowest material batch. FIG. 5 shows the curing time which is plotted against set mold temperature for the slowest curing batch material (upper curve) and fastest curing batch material (lower curve). FIG. 5 shows that the time savings are considerable, especially in the lower temperature range.

At low temperatures (up to 140° C.) the curing time reduction is approx. 60% which leads to a productivity gain of >50% considering also process off-times like mold opening and closing time, as well as demolding. At higher temperatures the process gain will be smaller (ca 10% curing time reduction at 170° C.).

For parts with a small surface-to-volume ratio (high voltage LSR insulators) that are molded at lower temperatures due to long filling time, the expected productivity gain is significant.

1. A method to produce parts by shaping and curing a raw material comprising the steps:
a batch of raw material is produced;
at least one cure property of the raw material of the sample is determined;
shaping the raw material;
the time required for the shaped raw material to cure is determined taking into account the at least one cure property;
curing of the shaped raw material until the determined time has elapsed.

2. The method according to claim 1, wherein the shaped raw material is heated to cure the shaped raw material and the supply of heat is stopped when the determined time has elapsed or wherein the shaped raw material is irradiated to cure the shaped raw material and the irradiation is stopped when the determined time has elapsed.

3. The method according to claim 1, wherein the raw material is brought into a mold and the shaped raw material is cured by heating the mold.

4. The method according to claim 3, wherein a finished part is removed from the mold as soon as the determined time has elapsed.

5. The method according to claim 1, wherein a processing unit which shapes the raw material and cures the shaped raw material includes a computer, which determines the time required for curing by calculation.

6. The method according to claim 1, wherein a processing a database stores one or more cure properties of each batch.

7. The method according to claim 1, wherein each batch comprises a code that can be used to identify the batch, wherein the code may be attached to a package of a batch.

8. The method according to claim 6, wherein a code reader reads the code, connects to the database after reading the code, receives the cure properties of the batch from the database after the connection is established and sends the obtained cure properties to a computer, which determines the time required for curing.

9. The method according to claim 8, wherein a cell phone is the code reader.

10. The method according to claim 1, wherein one or more cure properties of a batch of raw material are determined at several different temperatures.

11. The method according to claim 1, wherein a processing unit which is configured to shape raw material and is configured to cure the shaped raw material comprises a code and wherein a code reader establish a wireless data connection to a computer of the processing unit after reading the code.

12. A database for carrying out a method according to claim 1 which stores one or more cure properties of each batch and which is accessible via the Internet.

13. The database according to claim 12 wherein a cure property for each batch is stored which is determined at three different temperatures.

14. A system comprising a database according claim 12 and a processing unit for carrying out the method to produced parts.

15. The system according to claim 14 wherein the processing unit comprises a mold and heating means for heating the mold.
